(19) United States
(12) Patent Application Publication
(10) Pub. No.: US 2026/0008426 A1
(43) Pub. Date: Jan. 8, 2026

(54) Airbag Spot Blast Control Method, Device, Storage Media, Controller, and Vehicle

(71) Applicants: Robert Bosch GmbH, Stuttgart (DE); Bosch Automotive Products (Suzhou) Co. Ltd., Suzhou (CN)

(72) Inventors: Xiao Li, Suzhou (CN); Weiwei Wu, Suzhou (CN)

(21) Appl. No.: 19/256,953

(22) Filed: Jul. 1, 2025

(30) Foreign Application Priority Data
Jul. 5, 2024 (CN) 2024 1090 2760.5

(51) Int. Cl. B60R 21/0132; B60R 21/00; B60R 21/01; B60R 21/015

(52) U.S. Cl. CPC B60R 21/0132; B60R 21/01512; B60R 2021/0025; B60R 2021/01013; B60R 2021/01245; B60R 2021/01286

(57) ABSTRACT

The present invention provides a method of airbag spot blast control, device, storage media, vehicle controller and vehicle, according to the method of airbag spot blast control, obtaining the first transverse acceleration signal detected in real time by the first collision sensor and the second transverse acceleration signal detected in real time by the second collision sensor, and based on the first transverse acceleration signal and the second transverse acceleration signal, determine whether the collision to the vehicle is a frontal pole collision. When the collision is determined as frontal pole collision, the airbag spot blast threshold of the vehicle is lowered according to the preset threshold adjustment method. Then, based on the adjusted airbag spot blast threshold, airbag spot blast control is performed on the vehicle. This invention can solve the problem of the airbag not spot-blasting in time during a frontal pole collision, thereby improving safety.

This application claims priority under 35 U.S.C. § 119 to application no. CN 2024 1090 2760.5, filed on Jul. 5, 2024 in China, the disclosure of which is incorporated herein by reference in its entirety.

The present disclosure relates to the field of vehicle control technology, particularly to a method, device, storage media, controller and vehicle for airbag spot blast control.

### BACKGROUND

The electronic control of safety airbag system is a passive security protection system that provides effective anti-collision protection for occupants in the event of a vehicle collision.

In relevant techniques, the airbag control system typically uses longitudinal acceleration signals to decide whether to spot-blast the airbag when the vehicle has a frontal collision. However, in the case of pole collisions in the frontal collisions, due to the rigidity of the pole barrier and the small area of contact with the vehicle, the pole barrier will invade the vehicle body from the middle of the vehicle's front. During this period, the speed of the vehicle will not drop quickly, and the longitudinal acceleration signal of the vehicle will not change significantly. Therefore, the airbag controller will not quickly perceive the collision, so the airbag will not trigger the spot blast or even trigger.

### SUMMARY

Based on this, the present disclosure provides a method of airbag spot blast control, device, storage media, vehicle controller and vehicle. Using the method of airbag spot blast control, the airbag can reduce the threshold of airbag spot blast when there is a frontal collision and detect a frontal pole collision, so as to avoid the risk of the airbag not being able to trigger spot blast quickly when there is a frontal pole collision and improve the protection performance of the airbag.

In an aspect, the present disclosure provides a method of airbag spot blast control for application to a vehicle comprising at least two collision sensors comprising at least a first collision sensor disposed in the front left position of the body and a second collision sensor disposed in the front right position of the body comprising:
obtaining a first transverse acceleration signal detected in real time by a first collision sensor and a second transverse acceleration signal detected in real time by a second collision sensor;
determining whether a collision to the vehicle is a frontal pole collision based on the first and second transverse acceleration signals;
upon determining that the collision is a frontal pole collision, adjusting the airbag spot blast threshold of the vehicle according to a preset threshold adjustment method to perform airbag spot blast control on the vehicle based on the adjusted airbag spot blast threshold.

Further, in some embodiments, the determination of whether a collision to the vehicle is a frontal pole collision based on the first and second transverse acceleration signals comprises:

if both the first and second transverse acceleration signals are greater than a preset acceleration threshold and the direction of both the first and second transverse acceleration signals are directed inside the vehicle, determine that the collision to the vehicle is a frontal pole collision.

Further, in some embodiments, upon determining that the collision is a frontal pole collision, the airbag spot blast threshold for the vehicle is lowered according to a preset threshold adjustment method, comprising:
obtaining an airbag spot blast threshold determined based on a longitudinal acceleration signal comprising a first longitudinal acceleration signal detected in real time by a first collision sensor and a second longitudinal acceleration signal detected in real time by a second collision sensor;
determining a threshold adjustment amount of airbag spot blast corresponding to the frontal pole collision;
lowering the airbag spot blast threshold based on the airbag spot blast threshold adjustment amount.

Further, in some embodiments, the determination of an airbag spot blast threshold adjustment amount corresponding to a frontal pole collision comprises:
determining a pole collision level corresponding to the frontal pole collision based on the first and second transverse acceleration signals;
determining a threshold adjustment amount of airbag spot blast corresponding to the pole collision level.

Further, in some embodiments, upon determining that the collision is a frontal pole collision, the airbag spot blast threshold for the vehicle is lowered according to a preset threshold adjustment method, comprising:
determining a preset airbag spot blast threshold corresponding to the frontal pole collision;
setting the preset airbag spot blast threshold as the adjusted airbag spot blast threshold.

Further, in some embodiments, said vehicle is subjected to airbag spot blast control based on said adjusted airbag spot blast threshold, comprising:
obtaining a longitudinal acceleration of the vehicle, with the longitudinal acceleration of the vehicle being measured by a vehicle central acceleration sensor;
Spot-blasting airbags of the vehicle when the longitudinal acceleration of the vehicle is greater than the airbag spot blast threshold.

Further, in some embodiments, when the longitudinal acceleration of the vehicle is greater than the airbag spot blast threshold, the airbag of the vehicle is spot-blasted, comprising:
determining the ride position of in-vehicle occupants according to an occupant monitoring system of the vehicle when the longitudinal acceleration of the vehicle is greater than the airbag spot blast threshold;
Spot-blasting the safety airbags corresponding to the ride position.

In another aspect, the present disclosure provides an airbag spot blast control device, comprising:
a signal acquisition module for obtaining a first transverse acceleration signal detected in real time by a first collision sensor and a second transverse acceleration signal detected in real time by a second collision sensor;
a pole collision determination module for determining whether a collision to the vehicle is a frontal pole collision based on the first and second transverse acceleration signals;
a threshold determination module for lowering the airbag spot blast threshold of the vehicle according to a predetermined threshold adjustment method when the collision is determined to be a frontal pole collision;
a spot blast control module for performing airbag spot blast control on the vehicle based on the adjusted airbag spot blast threshold.

In another aspect, the present disclosure provides a storage medium stored with a computer program adapted for loading by a processor and performing the steps of the above described method.

In another aspect, the present disclosure also provides for a vehicle controller comprising: a processor and memory; wherein the memory stores a computer program adapted to be loaded by the processor and to perform the steps of the method described above.

In another aspect, the present disclosure also provides for a vehicle, including the airbag spot blast control device or vehicle controller described above.

According to the method of airbag spot blast control provided by the present disclosure, obtain the first transverse acceleration signal detected in real time by the first collision sensor and the second transverse acceleration signal detected in real time by the second collision sensor. Based on the first transverse acceleration signal and the second transverse acceleration signal, determine whether the collision to the vehicle is frontal pole collision. When the collision is determined as frontal pole collision, the airbag spot blast threshold of the vehicle is lowered according to the preset threshold adjustment method. The airbag spot blast control of the vehicle is then carried out based on the adjusted airbag spot blast threshold. By using this airbag spot blast control method, the current collision can be determined as a frontal pole collision based on the transverse acceleration detected by the collision sensor. When a frontal pole collision is detected, the airbag spot blast threshold is lowered to avoid the risk of the airbag failing to trigger and spot-blast quickly during such a collision, thereby improving the protective performance of the airbags.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

FIG. 1 is the system architecture diagram of the method for airbag spot blast control provided by the embodiments of the present disclosure;

FIG. 2 is a schematic diagram of the location of a collision sensor provided by the embodiments of the present disclosure;

FIG. 3 is an example schematic diagram of a frontal pole collision provided by the embodiments of the present disclosure;

FIG. 4 is a structural schematic diagram of an airbag spot blast control device provided by the embodiments of the present disclosure;

FIG. 5 is a structural schematic diagram of a vehicle controller provided by the embodiments of the present disclosure.

### DETAILED DESCRIPTION

In order to make the objects, technical solutions and advantages of the present disclosure more clear, the technical solutions of the present disclosure will be clearly and completely described below in combination with the specific embodiments of the present disclosure and the corresponding drawings. Obviously, the embodiments described are only part of the embodiments of the present disclosure, not all of them. Based on the embodiments in the present disclosure, all other embodiments obtained by one of ordinary skill in the art without creative work fall within the protection scope of the present disclosure.

In one or more descriptions of the embodiments of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to different or the same object. Other explicit and implicit definitions may be included below.

An airbag is a passive safety protection system that provides effective anti-collision protection for occupants when a vehicle collision occurs. The airbag system consists primarily of collision sensors, gas generators, ignition devices, airbags, and control units. The collision sensor is responsible for detecting the impact signal in the event of a collision in the vehicle, and the control unit determines whether the airbags need to be spot-blasted based on the information from the sensors. Once the preset conditions are met, the control unit will drive the gas generators to generate a large amount of gas, allowing the airbags to be rapidly inflated and ejected, forming an elastic gas pad before the occupant collides into the components of the vehicle, which will reduce the impact force on the human body.

In relevant techniques, a collision sensor is generally provided on the front side of the vehicle and on the sides of the vehicle, wherein the front side of the vehicle is generally provided with two collision sensors on the left and right sides respectively for detecting collision signals in the frontal collision condition. Frontal pole collision is a special collision condition in the frontal collision condition. frontal pole collision refers to the high-speed collision into a pole barrier in the front of the vehicle. Under the frontal pole collision condition, the entire energy of the body is concentrated in a smaller area. In the early stage, the pole barrier will penetrate into the vehicle body, and the longitudinal acceleration signal of the vehicle will not change greatly, thus preventing the safety airbag controller to quickly perceive the collision, the safety airbag will not be able to trigger rapid spot blast or even trigger, and the occupants will not be effectively protected.

Based on this, the present disclosure provides a method of airbag spot blast control. Obtain the first transverse acceleration signal detected in real time by the first collision sensor and the second transverse acceleration signal detected in real time by the second collision sensor. Based on the first transverse acceleration signal and the second transverse acceleration signal, determine whether the collision to the vehicle is frontal pole collision. When the collision is determined as frontal pole collision, the airbag spot blast threshold of the vehicle is lowered according to the preset threshold adjustment method. The airbag spot blast control of the vehicle is then carried out based on the adjusted airbag spot blast threshold. By using this airbag spot blast control method, the current collision can be determined as a frontal pole collision based on the transverse acceleration detected by the collision sensor. When a frontal pole collision is detected, the airbag spot blast threshold is lowered to avoid the risk of the airbag failing to trigger and spot-blast quickly during such a collision, thereby improving the protective performance of the airbags.

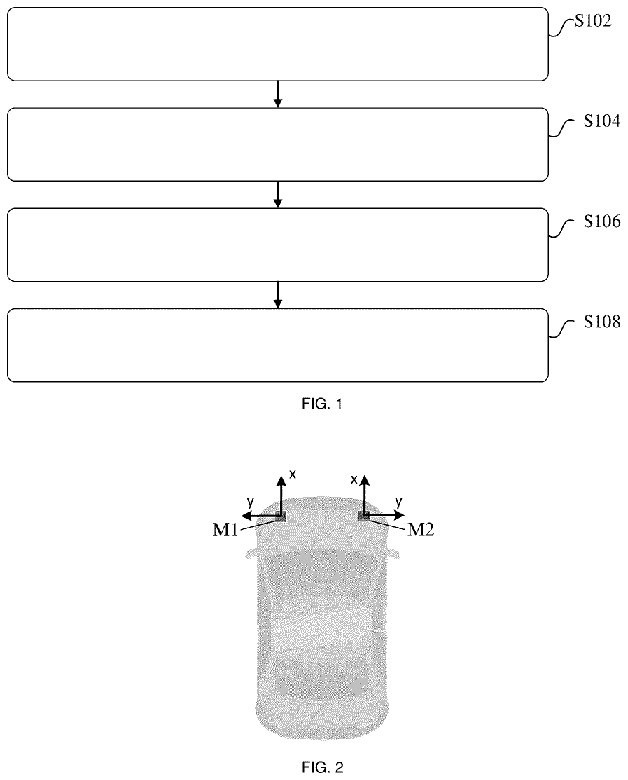

Please refer to FIG. 1 for the flow chart of a method for airbag spot blast control provided by the embodiments of the present disclosure. The process shown in FIG. 1 is described in detail below. The airbag spot blast control method is applied to a vehicle. The vehicle comprises at least two collision sensors, comprising a first collision sensor disposed in the left front position of the vehicle body and a second collision sensor disposed in the right front position of the vehicle body, and may specifically comprise the following steps:
Step S102: obtaining a first transverse acceleration signal detected in real time by a first collision sensor and a second transverse acceleration signal detected in real time by a second collision sensor;

It is to be noted that the first and second collision sensors are collision sensors disposed on the front of the vehicle for detecting collision signals in the event of a frontal collision of the vehicle. The first and second collision sensors are specifically acceleration sensors, which detect the change in acceleration signal in the collision process of the vehicle as one of the information for determining whether to spot-blast the airbag.

Please refer to FIG. 2, which is a schematic diagram of the location of a collision sensor provided by the embodiments of the present disclosure; As shown in FIG. 2, a first collision sensor M1 is provided in the front left position and a second collision sensor M2 is provided in the front right position of the body, wherein both the first and second collision sensors can be used to detect a transverse acceleration signal in the y direction and a longitudinal acceleration signal in the x direction.

In the embodiments of the present disclosure, the transverse acceleration signal detected by the first and second collision sensors is monitored in real time during operation of the vehicle. The first collision sensor detects the first transverse acceleration signal and the second collision sensor detects the second transverse acceleration signal.
Step S104: determine whether the collision to the vehicle is a frontal pole collision based on the first and second transverse acceleration signals;

Of which, the frontal pole collision refers to the collision of the front of the vehicle from the middle position to the pole. During the collision, the entire energy of the vehicle is concentrated on a smaller area at the middle of the front of the vehicle, which may cause the vehicle to have a larger structural deformation.

It is to be noted that when a pole collision occurs, the pole barrier impacts the vehicle from the middle of the front side of the vehicle, and due to the penetration of the pole barrier, the vehicle undergoes a deformation inwardly from the middle side of the front side of the vehicle, at which time the first collision sensor at the front left position of the vehicle and the second collision sensor at the front right position of the vehicle simultaneously detect a transverse acceleration signal pointing inside the vehicle. Thus, the type of collision to the vehicle may be determined from the first and second transverse acceleration signals to be a frontal pole collision, and when both the first and second transverse acceleration signals directed to the inside of the vehicle are detected simultaneously, the current collision may be determined to be a frontal pole collision.

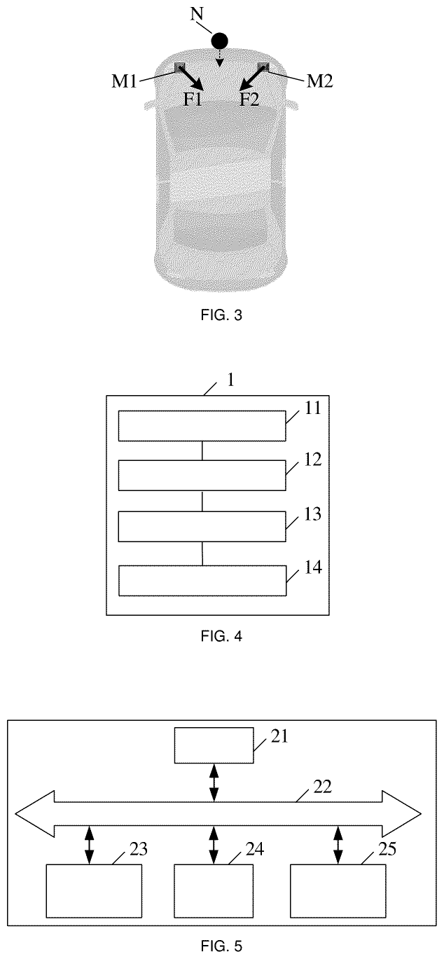

Please refer to FIG. 3, an example schematic diagram of a frontal pole collision provided by the embodiments of the present disclosure. As shown in FIG. 3, the front of the vehicle shown impact the pole barrier N. In the early stage of collision, the pole barrier N penetrates into the vehicle body in a dashed line. Due to the force in the two front middle positions, the first and second collision sensors M1, M2 are, at this time being, acted on by the force F1 and force F2 as shown. It is not difficult to see that based on the illustrated force F1 and force F2, a first collision sensor at the front left position can detect a first transverse acceleration signal directed to the right, a second collision sensor at the front right position can detect a second transverse acceleration signal directed to the left, both the first and second transverse acceleration signals directed to the inside of the vehicle.
Step S106: when the collision type is determined to be a frontal pole collision, the airbag spot blast threshold of the vehicle is lowered according to the preset threshold adjustment method;
Step S108: perform airbag spot blast control on the vehicle based on the adjusted airbag spot blast threshold.

In the embodiments of the present disclosure, when the collision is determined according to the transverse acceleration signal as a frontal pole collision, the vehicle airbag spot blast threshold is lowered according to the preset threshold adjustment method to conduct airbag spot blast control on the vehicle based on the adjusted airbag spot blast threshold.

It is not difficult to understand that in the event of a severe frontal pole collision, during the early part of the collision, the longitudinal acceleration of the vehicle may not be obviously changed due to the penetration of the pole barrier into the vehicle, thus the airbag spot blast cannot be triggered in time. In the embodiments of the present disclosure, when a frontal pole collision is detected, the safety of the driver can be protected by lowering the airbag spot blast threshold of the vehicle so that even if the change in the longitudinal acceleration of the vehicle is not obvious at the early stage of the collision, the airbag spot blast can be triggered in a timely manner.

In an embodiment, step S104 determines whether the collision to the vehicle is a frontal pole collision based on the first and second transverse acceleration signals, which may specifically be:
if both the first and second transverse acceleration signals are greater than a preset acceleration threshold and the direction of both the first and second transverse acceleration signals are directed inside the vehicle, determine that the collision to the vehicle is a frontal pole collision.

It will be understood that when the vehicle is in a frontal pole collision condition, the pole barrier impacts the vehicle from the middle of the front side of the vehicle, and due to the penetration of the pole barrier, the vehicle undergoes a deformation inwardly from the middle side of the front side of the vehicle, at which time the first collision sensor at the front left position of the vehicle and the second collision sensor at the front right position of the vehicle simultaneously detect a transverse acceleration signal pointing inside the vehicle. In the embodiments of the present disclosure, when both the first and second transverse acceleration signals are greater than the preset acceleration threshold, and the direction of both the first and second transverse acceleration signals point to the inside of the vehicle, it can be determined that the collision to the vehicle is a frontal pole collision, thereby lowering the airbag spot blast threshold according to the frontal pole collision type, and solving the problem that the change in the longitudinal acceleration of the vehicle in the early collision does not significantly trigger the airbag spot blast in time.

In an embodiment, step S106, when the collision type is determined to be a frontal pole collision, the airbag spot blast threshold of the vehicle is lowered according to the preset threshold adjustment method. Specifically, it can include the following steps:
Step S1061: obtaining an airbag spot blast threshold determined based on a longitudinal acceleration signal comprising a first longitudinal acceleration signal detected in real time by a first collision sensor and a second longitudinal acceleration signal detected in real time by a second collision sensor;
wherein the airbag spot blast threshold is an acceleration value.

It is to be noted that airbag spot blast thresholds are different for different collision conditions, which are typically determined based on acceleration signals detected by the collision sensor. When a collision occurs on the front of the vehicle without regard to the frontal pole collision, the airbag spot blast threshold in the current collision condition is typically determined based on the longitudinal acceleration signal detected by the first and second collision sensors disposed on the front of the vehicle. For example, by integrating the longitudinal acceleration signal, the amount of change in the speed of the vehicle when the collision occurs can be obtained, the greater the change in the speed, the greater the degree of collision, and different airbag spot blast thresholds can be set for different degrees of collision.

That is, the airbag spot blast threshold determined based on the longitudinal acceleration signal is the airbag spot blast threshold set without regard to the frontal pole collision.
Step S1062: determine a threshold adjustment amount of airbag spot blast corresponding to the frontal pole collision;

Specifically, the airbag spot blast threshold adjustment amount pre-set in the frontal pole collision condition is adjusted to adjust the airbag spot blast threshold obtained in Step S1061 according to the airbag spot blast threshold adjustment when determining the collision is a frontal pole collision.
Step S1063: adjust the amount to lower the airbag spot blast threshold based on the airbag spot blast threshold.

In the embodiments of the present disclosure, by setting the airbag spot blast threshold adjustment amount corresponding to the preset frontal pole collision condition, when a frontal pole collision is detected, the airbag spot blast threshold is lowered based on the airbag spot blast threshold adjustment, the issue of the airbag spot blast being unable to be triggered in time due to insignificant change in longitudinal acceleration of the vehicle in the early stage of the collision is solved.

In an embodiment, step S1062, the airbag spot blast threshold adjustment amount corresponding to the collision of the front column is determined, which may be:
determining a pole collision level corresponding to the frontal pole collision based on the first and second transverse acceleration signals;
determining a threshold adjustment amount of airbag spot blast corresponding to the pole collision level.

In an embodiment, step S106, when the collision type is determined to be a frontal pole collision, the airbag spot blast threshold of the vehicle is lowered according to the preset threshold adjustment method. Specifically, it can be: Determine the preset airbag spot blast threshold corresponding to the frontal pole collision and use the preset airbag spot blast threshold as the adjusted airbag spot blast threshold.

Of which, the preset airbag spot blast threshold is the preset airbag spot blast threshold. This preset airbag spot blast threshold can avoid the problem that the airbag spot blast cannot be triggered in time due to the change in the longitudinal acceleration of the vehicle in the early stage of collision.

The preset airbag spot blast threshold is used as the threshold for determining whether the airbag should be spot-blasted. Even if the change in the longitudinal acceleration of the vehicle in the early stage of collision is not obviously, the airbag spot blast can be triggered in time, thus protecting the safety of the driver.

In an embodiment, step S108, perform airbag spot blast control on the vehicle based on the adjusted airbag spot blast threshold. Specifically, it can be: The longitudinal acceleration of the vehicle is acquired and measured by the vehicle central acceleration sensor and the airbag of the vehicle is spot-blasted when the longitudinal acceleration of the vehicle is greater than the airbag spot blast threshold.

It is understood that the frontal pole collision is a frontal collision. When in a frontal collision condition, the vehicle's longitudinal acceleration is used to determine whether to spot-blast the airbag. Specifically, when the longitudinal acceleration of the vehicle is greater than the airbag spot blast threshold, the airbag of the vehicle is spot-blasted; when the longitudinal acceleration of the vehicle is less than or equal to the airbag spot blast threshold, the airbag of the vehicle is not spot-blasted.

wherein the longitudinal acceleration of the vehicle is measured by the vehicle central acceleration sensor. The central acceleration sensor is typically disposed inside the vehicle and in the event of a collision, the vehicle's acceleration test result is not affected by the vehicle deformation. A feasible embodiment, the central acceleration sensor is disposed on the airbag controller.

In an embodiment, when the longitudinal acceleration of the vehicle is greater than the airbag spot blast threshold, the airbag of the vehicle will be spot-blasted. Specifically, it can be: Determining the ride position of in-vehicle occupants according to an occupant monitoring system of the vehicle and spot-blast the corresponding airbags when the longitudinal acceleration of the vehicle is greater than the airbag spot blast threshold.

Of which, the occupant detection system may determine the ride position of the rider based on the interior camera, the pressure sensor disposed on the seats, whether the seat belt is configured, etc.

In the embodiments of the present disclosure, when the longitudinal acceleration of the vehicle is greater than the airbag spot blast threshold, by determining the ride position of the occupant in the vehicle, only the airbag at the ride position of the occupant is controlled and spot-blasted, not the airbag at the ride position without an occupant.

In a specific application scenario, when the vehicle is subject to a frontal collision, obtain the first transverse acceleration signal detected by the first collision sensor set at the front left position of the vehicle, and obtain the second transverse acceleration signal detected by the second collision sensor set at the right position of the vehicle. Based on the first and second transverse acceleration signals, it is determined whether the collision is a frontal pole collision. If both the first and second transverse acceleration signals are greater than a preset acceleration threshold, and the directions of both signals point toward the inside of the vehicle, the collision is determined to be a frontal pole collision. When it is determined that the collision is a frontal pole collision, the airbag spot blast threshold of the vehicle is lowered according to a preset threshold adjustment method, and the longitudinal acceleration of the vehicle detected by the central acceleration sensor in the airbag controller is obtained. When the vehicle's longitudinal acceleration exceeds the adjusted airbag spot blast threshold, the airbag is triggered to spot-blast. Determine whether a frontal pole collision happened by using the transverse acceleration signal collected by the first and second collision sensors on the front of the vehicle. When determining the frontal pole collision, lower the airbag spot blast threshold, and solve the problem that the change in the longitudinal acceleration of the vehicle is not obvious in the early stage of collision and does not trigger the airbag spot blast. The adjusted airbag spot blast threshold makes it possible to trigger the airbag spot blast in time even if the change in the longitudinal acceleration of the vehicle is not obvious in the early stage of collision.

Please refer to FIG. 4 for the structural schematic diagram of an airbag spot blast control device provided by the embodiments of the present disclosure. As shown in FIG. 4, the airbag spot blast control device 1 may be implemented as a whole or part of a vehicle controller by a combination of software, hardware, or both. According to some embodiments, the airbag spot blast control device 1 includes a signal acquisition module 11, a pole collision determination module 12, a threshold adjustment module 13, and a spot blast control module 14, comprising:
a signal acquisition module 11 for obtaining a first transverse acceleration signal detected in real time by a first collision sensor and a second transverse acceleration signal detected in real time by a second collision sensor;
a pole collision determination module 12 for determining whether a collision to the vehicle is a frontal pole collision based on the first and second transverse acceleration signals;
a threshold determination module 13 for lowering the airbag spot blast threshold of the vehicle according to a predetermined threshold adjustment method when the collision is determined to be a frontal pole collision;
a spot blast control module 14 for performing airbag spot blast control on the vehicle based on the adjusted airbag spot blast threshold.

Optionally, the pole collision determination module 12, which is specifically used to:
if both the first and second transverse acceleration signals are greater than a preset acceleration threshold and the direction of both the first and second transverse acceleration signals are directed inside the vehicle, determine that the collision to the vehicle is a frontal pole collision.

Optionally, the threshold adjustment module 13, which is specifically used to:
obtaining an airbag spot blast threshold determined based on a longitudinal acceleration signal comprising a first longitudinal acceleration signal detected in real time by a first collision sensor and a second longitudinal acceleration signal detected in real time by a second collision sensor;
determining a threshold adjustment amount of airbag spot blast corresponding to the frontal pole collision;
lowering the airbag spot blast threshold based on the airbag spot blast threshold adjustment amount.

Optionally, the threshold adjustment module 13 when performing the determination of the airbag spot blast threshold adjustment amount corresponding to the collision of the front column, is specifically used to:
determining a pole collision level corresponding to the frontal pole collision based on the first and second transverse acceleration signals;
determining a threshold adjustment amount of airbag spot blast corresponding to the pole collision level.

Optionally, the threshold adjustment module 13, which is specifically used to:
determining a preset airbag spot blast threshold corresponding to the frontal pole collision; setting the preset airbag spot blast threshold as the adjusted airbag spot blast threshold.

Optionally, the spot blast control module 14, which is specifically used to:
obtaining a longitudinal acceleration of the vehicle, with the longitudinal acceleration of the vehicle being measured by a vehicle central acceleration sensor;
Spot-blasting airbags of the vehicle when the longitudinal acceleration of the vehicle is greater than the airbag spot blast threshold.

Optionally, the spot blast control module 14 performing the spot blast for the airbags of the vehicle when said vehicle's longitudinal acceleration is greater than the airbag spot blast threshold, which is specifically used to:
determining the ride position of in-vehicle occupants according to an occupant monitoring system of the vehicle when the longitudinal acceleration of the vehicle is greater than the airbag spot blast threshold;
Spot-blasting the safety airbags corresponding to the ride position.

The above device embodiments correspond to the embodiment of the method. For specific description, please refer to the description of the embodiment of the method, which will not be repeated here. The device embodiment is obtained based on the corresponding method embodiment and has the same technical effect as the corresponding method embodiment. Refer to the corresponding method embodiment for the specific description.

The present disclosure also provides a storage medium that can store multiple instructions adapted for loading and execution by a processor of a method of airbag spot blast control as described in the above embodiments. The specific execution process can refer to the specific description in the above embodiments and is not described in detail here.

The present disclosure also provides a computer program product that stores at least one instruction, which is loaded by the processor and executes a method of airbag spot blast control as described in the above embodiments. The specific execution process can refer to the specific description in the above embodiments and is not described here.

In an embodiment, the present disclosure also provides a structural schematic diagram of the vehicle controller shown in FIG. 5. As shown in FIG. 5, at the hardware level, the vehicle controller includes a processor 21, an internal bus 22, a network interface 23, memory 24, and non-volatile memory 25, and of course may also include hardware required for other business. The vehicle controller may be disposed in the vehicle, wherein the processor 21 reads a corresponding computer program from the non-volatile memory 25 into the memory and then operates to implement the above described method of airbag spot blast control.

Optionally, the vehicle controller may be, in particular, an airbag controller.

In an embodiment, the present disclosure also provides a vehicle that may include an airbag spot blast control device or vehicle controller as described above to perform an airbag spot blast control method through the airbag spot blast control device or vehicle controller to improve vehicle safety.

Finally, the various embodiments in the present disclosure are described in a progressive manner. The same parts of each embodiment can be seen from each other. Each embodiment focuses on different aspects than the other embodiments. In particular, for system embodiments, since it is substantially similar to the method embodiments, the description is relatively simple, and relevant aspects are only described in part of the method embodiments.

The foregoing is merely the embodiments of the disclosure and is not intended to limit the disclosure. Various changes and variations may be made to the present disclosure to those skilled in the art. Any modifications, equivalent substitutions, improvements, etc. made within the spirit and principles of the present disclosure shall be included within the scope of the claims of the present disclosure.

What is claimed is:

1. An airbag spot blast control method for a vehicle, wherein the vehicle includes at least two collision sensors, comprising a first collision sensor disposed in the left front position of a vehicle body and a second collision sensor disposed in the right front position of the vehicle body, the method comprising:
obtaining a first transverse acceleration signal detected in real time by a first collision sensor and a second transverse acceleration signal detected in real time by a second collision sensor;
determining whether a collision to the vehicle is a frontal pole collision based on the first and second transverse acceleration signals;
lowering the airbag spot blast threshold of the vehicle according to a predetermined threshold adjustment method when the collision is determined to be the frontal pole collision; and
performing airbag spot blast control on the vehicle based on the adjusted airbag spot blast threshold.

2. The method according to claim 1, wherein the determination of whether the collision to the vehicle is the frontal pole collision based on the first and second transverse acceleration signals comprises:
if both the first and second transverse acceleration signals are greater than a preset acceleration threshold and the direction of both the first and second transverse acceleration signals are directed inside the vehicle, determining that the collision to the vehicle is the frontal pole collision.

3. The method according to claim 1, wherein upon determining that the collision is the frontal pole collision, the airbag spot blast threshold for the vehicle is lowered according to a preset threshold adjustment method, comprising:
obtaining an airbag spot blast threshold determined based on a longitudinal acceleration signal comprising a first longitudinal acceleration signal detected in real time by a first collision sensor and a second longitudinal acceleration signal detected in real time by a second collision sensor;
determining a threshold adjustment amount of airbag spot blast corresponding to the frontal pole collision; and
lowering the airbag spot blast threshold based on the airbag spot blast threshold adjustment amount.

4. The method according to claim 3, wherein the determination of the airbag spot blast threshold adjustment amount corresponding to the frontal pole collision comprises:
determining a pole collision level corresponding to the frontal pole collision based on the first and second transverse acceleration signals; and
determining a threshold adjustment amount of airbag spot blast corresponding to the pole collision level.

5. The method according to claim 1, wherein upon determining that the collision is the frontal pole collision, the airbag spot blast threshold for the vehicle is lowered according to a preset threshold adjustment method, comprising:
determining a preset airbag spot blast threshold corresponding to the frontal pole collision; and
setting the preset airbag spot blast threshold as the adjusted airbag spot blast threshold.

6. The method according to claim 1, wherein performing airbag spot blast control on the vehicle based on the adjusted airbag spot blast threshold comprises:
obtaining a longitudinal acceleration of the vehicle, with the longitudinal acceleration of the vehicle being measured by a vehicle central acceleration sensor;
spot-blasting airbags of the vehicle when the longitudinal acceleration of the vehicle is greater than the airbag spot blast threshold.

7. The method according to claim 6, wherein when the longitudinal acceleration of the vehicle is greater than the airbag spot blast threshold, the airbag of the vehicle is spot-blasted, comprising:
determining the ride position of in-vehicle occupants according to an occupant monitoring system of the vehicle when the longitudinal acceleration of the vehicle is greater than the airbag spot blast threshold; and
spot-blasting the safety airbags corresponding to the ride position.

8. An airbag spot blast control device, comprising:
a signal acquisition module configured to obtain a first transverse acceleration signal detected in real time by a first collision sensor and a second transverse acceleration signal detected in real time by a second collision sensor;
a pole collision determination module configured to determine whether a collision to the vehicle is a frontal pole collision based on the first and second transverse acceleration signals;
a threshold determination module configured to lower the airbag spot blast threshold of the vehicle according to a predetermined threshold adjustment method when the collision is determined to be the frontal pole collision; and
a spot blast control module configured to perform airbag spot blast control on the vehicle based on the adjusted airbag spot blast threshold.

9. A storage medium having stored thereon a computer program that, when executed by a processor, implements the method according to claim 1.

10. A vehicle controller, comprising: a processor and memory; wherein the memory stores a computer program adapted to be loaded by the processor and implements the method according to claim 1.

11. A vehicle comprising the airbag spot blast control device of claim 8.

12. A vehicle comprising the vehicle controller of claim 10.
